(19) United States
(12) Patent Application Publication
(10) Pub. No.: US 2020/0268209 A1
(43) Pub. Date: Aug. 27, 2020

(54) MACHINE AND METHOD FOR CHARGING CULINARY CREAM WHIPPERS

(71) Applicant: OXYCOM SPA, Concepcion (CL)

(72) Inventor: Octavio MUNOZ FUENTEALBA, Concepcion (CL)

(21) Appl. No.: 16/761,122

(22) PCT Filed: Oct. 25, 2018
(86) PCT No.: PCT/IB2018/058349

§ 371 Date: May 1, 2020

(30) Foreign Application Priority Data
Nov. 2, 2017 (CL) 2771-2017

(51) Int. Cl. A47J 43/12; A23C 13/12; A23P 30/40; F17C 13/02; B65D 83/14; B65D 83/42; B67D 1/00; B67D 1/04

(52) U.S. Cl. CPC A47J 43/125; A23C 13/12; A23P 30/40; F17C 13/025; B65D 83/14; F17C 2205/0326; B67D 1/00; B67D 1/04; F17C 2201/0104; F17C 2221/01; F17C 2223/035; B65D 83/42

(57) ABSTRACT

A machine and method for charging culinary cream whippers, by automatically injecting nitrous oxide, which makes it possible to optimise the charging time of culinary whippers and the availability of nitrous oxide for culinary whippers is disclosed, which has: a cabinet, wherein a first compartment is defined with its front portion open, at the base of which a nitrous oxide intake unit is arranged, external to this first compartment. The intake unit in the first compartment connects with a charging spout of the culinary whipper; inside the cabinet, in a second compartment, with a door, are provided at least one high-pressure nitrous oxide cylinder and the corresponding pneumatic, electric and electronic connections; and in the front of the machine is defined a control panel that makes it possible to operate the machine.

The object of the present invention is to provide a machine for charging siphons for the whipped cream, by injecting automatically nitrous oxide from at least one cylinder of 500 g or half a kg.

### BACKGROUND INFORMATION

The kitchen siphon is an instrument to make foam that was invented by Ferran Adria in 1985, based on the invention that was already created of the beverage siphon that served to gasify liquids.

They are made of stainless steel or aluminum with metal and synthetic parts that are resistant to the dishwasher. Normally, a siphon has at least one fluid reservoir, a head, a funnel and some cartridges, which are usually called pellets.

The first things we need to have into consideration are the siphon parts. We have the body of the siphon and its head. The charges and feeders are inserted in the head. The body of the siphon consists on a glass that has different sizes: half a liter, a liter and a liter and a half. Those are normally manufactured in stainless steel which is suitable to make hot and cold preparations. The head makes it possible that the gas mixture that we introduce in the elaborations does not escape. Moreover, three types of nozzles are introduced which are used depending on the purpose of the product and how we want to decorate it. We can do smooth or grooved drawings. The chargers are what make it possible for us to prepare foams, cream, mousses, etc. Those are charged with Nitrous oxide (N2O), colorless gas with a sweet smell and each charge or load usually holds ½ liter of product and it is usually supplied as sealed pellets, which are opened by inserting this pellet into the siphon which breaks the seal and releasing its load to the siphon. Finally, it is important to move the device energetically for 3 or 4 times from the top to bottom.

On the other hand, we have three types of foams that we identify by the base which one is going to be used, in other words, if the base is a fat, a jelly, egg whites or egg yolks. We can obtain cold foams with fat and jelly. Moreover, we will have a main ingredient that can be a fruit, juice, nuts, etc. In addition to cold foams, we can obtain hot foams with the same main ingredients.

In the prior art, the patent EP1428791B1 is known by Dr Ladi Zsolt, that illustrates a conventional kitchen siphon which was composed by a container with a pouring nozzle that allows coupling a load pellet and when releases its gas load, allows to pour the product that is in the container.

The WO2009112706 A of Lion Mathieu, there is a kitchen equipment of a siphon type for whipped cream which has a fluid reservoir, a head, a funnel and at least one gas cartridge. According to the invention, the equipment has a support for its placement, with a base that has: a hollow housing to receive the funnel and the fluid reservoir, in a situation of aeration of the two elements; a stop to insert the head and at least one suitable socket to hold the gas cartridge.

### OBJECTIVES

Currently, the use of kitchen siphons with nitrous oxide pellets is widely used in food areas such as: coffee shops, restaurants and others. The world's largest pellets factory is located in Europe where they are distributed around the world.

The nitrous oxide pellets are mainly imported from Austria to The United States. These pellets are dangerous and must go through a review by the Health Authority and pay for special storage apart from other costs. The companies that use them must have the necessary stock to cover the high demands of coffee and cream. They tend to run out of stock.

On the other hand, the pellets must be handled extremely carefully because of the nitrous oxide inside them which can represent a danger for the user because is highly flammable. Furthermore, as a general line, the pellet must be directly discarded after being used without having a residual management, which accumulate a huge amount of waste worldwide.

The present invention was born from the need to optimize safely a kitchen siphon with nitrous oxide from a high pressure cylinder to the operator and the consumer. Furthermore, to increase the availability of the nitrous oxide, increase the efficiency in the use of the cream reducing the losses, obtain different cream textures and adequately monitor the load and pressure of the nitrous oxide used.

An important advantage related to the most usual siphon charge is with gas from a pellet. However, it is not possible to adjust the mixture of gas and cream without increasing the amount of pellets in systems that use pellets. In other words, there is no control over the quality of the mixture from a single pellet. In this one is possible to modify the gas flow because it can generate more production with less cream injecting more or less nitrous oxide. However, this is achieved by replacing the pellet for a machine of automatic and controlled delivery of nitrous oxide. Then, the kitchen siphon is joined to the machine, allowing the delivery of cream through its pouring nozzle.

However, it is an important advantage of safety and control that is achieved over the maintenance and operation of the high pressure cylinders in which the nitrous oxide gas is stored and supplied. This is obtained through a closed system with sensors, box control and the possibility of a monitor system. Another important advantage of this present invention is the possibility of supplying, the charge of nitrous oxide “just on time” through an electronic control of the stock of the load of nitrous oxide in the cylinders of high pressure of load.

Additionally, there is a possibility of having electronic systems to control the quantity of nitrous oxide in the cream, and the consumer can select the type of cream desired, for example if its “light” or “ thick”.

### DESCRIPTION OF THE INVENTION

The present invention is related to a machine that loads siphons for the whipped cream through the automatically injection of nitrous oxide from high pressure cylinders that has: an enclosure which is divided in two zones or compartments. The first one is an enclosure or cabinet, where is defined the first compartment with an open front part in which base has a set of nitrous oxide from a high pressure nitrous oxide cylinders.

The second compartment inside the enclosure, in a non-visible way—the cylinders of high pressure are located with the appropriate pneumatic and electronic connections. Moreover, in front of the enclosure there is a control panel that allows operating the machine with at least one selector switch, lights, a start-up switch and a reset selector. This second compartment has an entrance door with a lock to prevent external manipulation.

Otherwise, the machine to charge siphons allows the number and size of the high pressure cylinders to be varied depending on the needs of the user, in other words, it can use one or more cylinders with different capacities. On the other hand, the size and shape of the enclosure can vary to be adapted to the requirements of the space and operating conditions.

Otherwise, the high pressure cylinders are connected with regulators that have a valve to regulate the output to an electro valve and an anemometer to visualize the passage of nitrous oxide and have it controlled.

Furthermore, there is a controller which works with the signals of an infrared sensor to detect the siphon with the ON/OFF selector and with the start-up selector and which commands the pilot lights, the variable display screen and the electrovalve. Moreover, the electrovalve is activated and keeps a count of loads of nitrous oxide, the dates and provides the amount of nitrous oxide that has been spent in a period of time.

Otherwise, there is a cellular connection, WIFI o GPRS, with a controller for remote operation monitoring,

A wheel system is defined to make an easier transportation and without complications.

Conversely, a method is defined to charge a siphon which allows charging siphons for whipped cream through the automatic injection of nitrous oxide N2O, where 330 ml of cream is added in the siphon, 40 ml of syrup, 8.2 gr of nitrous oxide. Moreover, remember to bear in mind that we do not have to forget that the position of the rubber cream is correct in order to not generate residues due to the pressure of the nitrous oxide. Then, insert the siphon into the piece and rotate in the same direction as the clock. Use more force than normal.

The proportions of cream or syrup can vary depending on the textures required by the user or consumer.

To turn on the machine, turn the selector to the ON position. Then, verify that the machine is on, in other words, that the green light is on and start charging pressing the green button. The green light will come on indicating that everything is ready for the charge.

Then, wait 40 seconds until the red light turns off and the green light is on again, that means the charge is completed and you can remove the siphon and get ready to make cream. The loading time varies to have different textures depending on the needs of the user. More time is proportional to a high charge of nitrous oxide creating a cream with a different texture.

Reset the system pressing the grey button of the machine in which the machine will be ready to start a new loading process and you can go back to the beginning,

In addition, the delivery provides from 1500 portions of cream through a standard siphon.

This machine is focused in the following areas:

Firstly, it increases the availability of the product, in this case the nitrous oxide is on demand due to a high pressure cylinder allows the elimination of 1000 pellets and the availability on-site can increase to resolve the requirements of the user.

Secondly, it allows reducing the pellets residues since it is supplied with interchangeable cylinders that can be reloaded.

Thirdly, the risk of storage pellets decreases due to they are replaced for a high pressure cylinder which has the proper characteristics for safe storage.

Fourthly, it increases the safety, efficiency and effectiveness in the operation of nitrous oxide high pressure cylinders and their connections, by using controllers, sensors and monitoring, even with the possibility of doing it remotely. The security is also increased by the fixed connection to the kitchen siphon, the possibility of closing the access to the high pressure cylinders, as well as the reduction of the need for user interaction with the nitrous oxide high pressure cylinders during the operation of the machine. It also highlights the increase in safety given by the infrared sensor of the siphon that prevents the injection of nitrous oxide if it is not installed in the right position.

Fifthly, the cost is reduced because there is no need to pay a lot of money for a product (N2O) because the containers are bought anywhere in the world without the need to wait for a shipment. Another advantage is that the N2O is produced in any country in the world.

Finally, it allows obtaining different cream textures through the different proportions of cream and nitrous oxide used from the same high pressure cylinder.

According to the advantages of the invention there are some key words to take into consideration: advantage of availability, environmental advantage, productive advantage and safety advantage.

Advantage of availability: They can have the necessary portions of cream without depending on a pellet, and keep a stable production according to the cylinder that is joined to the machine. For example, with a cylinder of half a kg it is possible to make more than 6.000 “frapuccino” without waiting for a recharge. To get the same amount of portions we need more than 6000 pellets. It can vary depending on the size of the cylinder used.

Environmental advantage: Currently in Chile any important company consumes at least 60.000 pellets which generate a direct waste of 60.000 pellets that go directly to the trash. This invention does not generate any residues because you can recharge it as many times as necessary.

Productive advantage: The portion of cream can be more “aerated” and at a lower cost, reduces the residues of the cream and eliminates import risks and simplifies the process for the operator. Moreover, there is a high control and monitoring of the loading process of the nitrous oxide inside the containers through the controllers that the machine has.

Safety advantage: Reduce the risks associated to the use of pellets, the damage of the cylinders to their connections and to their users as well.

### DESCRIPTION OF DRAWINGS

The present invention and other features and advantages will be shown from he following description with some drawings, in which:

FIG. 1. The figure illustrates a kitchen siphon of the ancient art.

FIG. 2. It represents a frontal view showing the location of the equipments and elements that will be manipulated by a well-educated operator.

FIG. 3. The figure represents a side view in which it is shown the inside part of the equipment and the elements that must be manipulated in case of maintenance or change of cylinders.

FIG. 4. The figure represents the inside of the machine but in a frontal view. At this level the monitor should know the location of each component and where it is connected to the movement of the nitrous oxide.

FIG. 5. The image represents the installation detail of the high pressure nitrous oxide cylinders.

### DETAILED DESCRIPTION

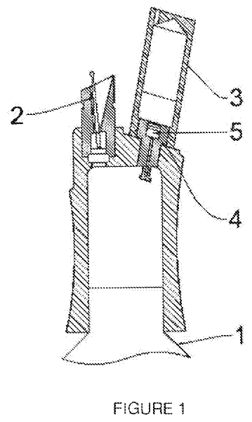

FIG. 1 shows a typical kitchen siphon which has: a container (1) with a pouring nozzle (2), the charging cartridge (3), where is installed the load pellet, Every time the siphon is used, the pellet is inserted in the charging cartridge (3). The cartridge and the pellet are screwed into the load python (4) and the pellet is drilled in a perforated side (5). Then, the product is liberated through the nozzle (2) managing a lever or handle.

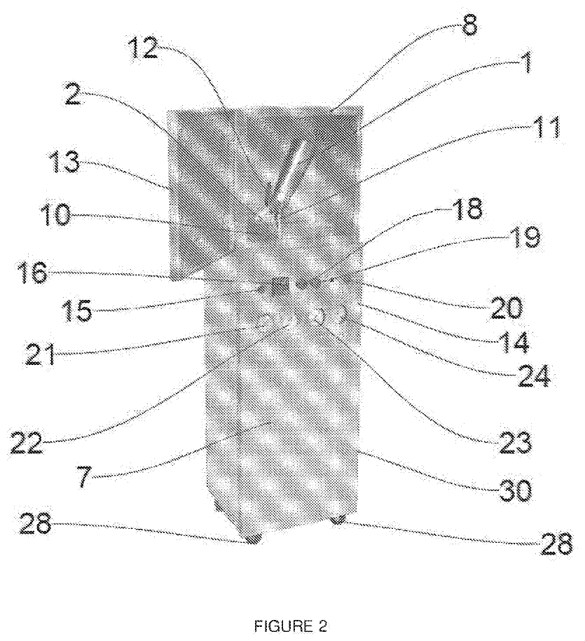

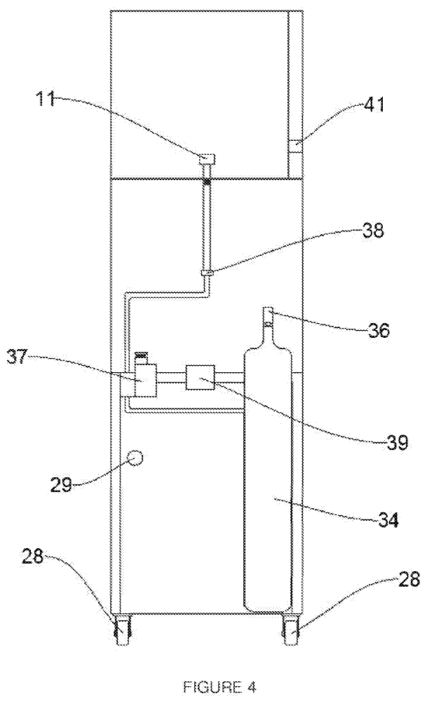

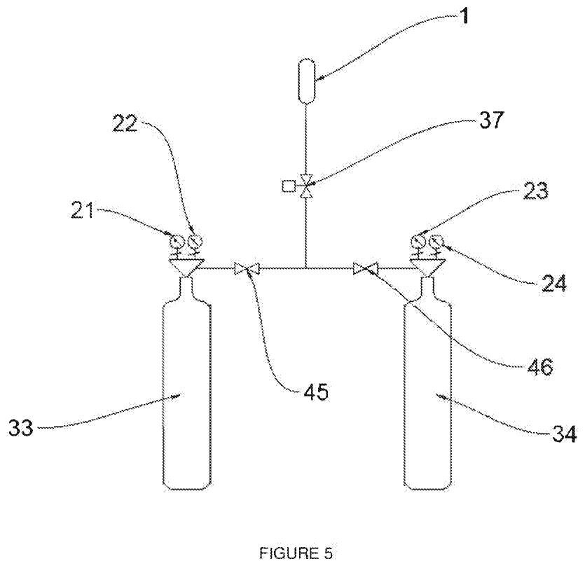

According to FIGS. 2, 3, 4 and 5, it is represented a preferred invention in which the nitrous oxide injection machine (6) has an structure of stainless steel or polycarbonate, which defines an enclosure (7) with two compartments. The first compartment is in an upper zone (8) and the second compartment is in a lower zone (30). The upper zone (8) of the first compartment (9) has an open frontal part with a door (13) to close it. It's first function is to accommodate the kitchen siphons (1) to pour cream.

The first rectangular compartment (9) from its lower base (10) defines a ser or conjunction of nitrous oxide (11) to connect the kitchen siphon (1) in its load python (4), so that the kitchen siphon (1) is inverted with the lever (12) in position to be operated by an user and with the pouring nozzle (2) in position to load the cream into a dispenser.

The nitrous oxide has a complementary connector to the kitchen siphon connector, so that it can be attached by screwing the kitchen siphon python or by coupling the kitchen siphon in a quick coupling.

In the front part of the machine (6) an operation panel is defined (14) that consists on an ignition selector (15), a variable display screen (16) such us: counting nitrous oxide loads in the kitchen siphon (1), a system operation, lights (18,19) lights and indicators of the kitchen siphon (1) a start-up selector (20), a reset selector and manometers (21, 22, 23, 24).

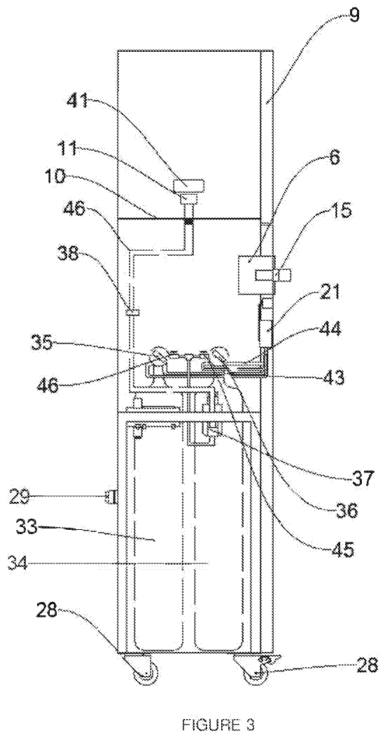

In the back part and referring to FIG. 3 is defined a female plug (29) that allows the machine to be connect to a power supply circuit.

Inside the second compartment in the lower zone (30) of the machine (6), behind a secure access door, there are the high pressure cylinders (33,34) with its corresponding electric circuits.

On the other hand, the enclosure of the nitrous oxide comprises the first compartment and a second one in the back part that is not visible. The electrical circuits and nitrous oxide charging circuit are in the back part of the second compartment.

Aditionally, the machine enclosure comprises the first compartment as I described before, and also a second lateral compartment in which both of them are near in a non-visible area. The nitrous oxide cylinders (33,34) and their corresponding electrical circuits are arranged in the second lateral compartment.

Alternatively, the first zone or compartment of the nitrous oxide machine enclosure in which base (10) the nitrous oxide (11) does not have a roof, door and at least two of its walls, leaving the access to the kitchen siphon and keeping everything else as described before.

The three last alternatives correspond to the need to adapt the size and shape of the “enclosure” or cabinet housing to other requirements given by the space or environment where the machine siphon should be located.

The nitrous oxide charging system has a pair of high pressure cylinders (33, 34) that are connected in parallel to the nitrous oxide (11). Also, there is a manometer in each high pressure cylinder of the primary one (21) and a manometer of pressure control of the primary cylinder as well (22) and a manometer of output pressure control of the second cylinder (23) and another manometer of high pressure control of the second cylinder (24). Therefore, each high pressure cylinder will have two manometers that work with two pressures (input- output) and one for charge.

The high pressure cylinders (33,34) are connected with regulators (35,36) that will have an output valve to regulate the output to an electrovalve (37) and an anemometer (38) to visualize the pouring of the nitrous oxide and have it controlled.

A controller (39), that works with infrared signals (41), that allows to detect the siphon with the switch selector (15) and with the start-up selector (20) which controls the pilot lights (18, 19), the variable display screen (16) and the electrovalve (37). Moreover, it manipulates the time variable when the electrovalve (37) is activated and keeps a count of charges that are made of nitrous oxide. Optionally, it includes remote connection and remote operation.

The operation panel also has selection buttons for their users to choose what type of milk they desire, in other words, they can be defined for automatic activations through a valve (37). Then, the controller regulates the amount of nitrous oxide that will be injected into the cream. The buttons will have different types of cream such as: thick cream, light cream or another.

For connecting the elements of the nitrous oxide charging system we need to use flexible stainless steel hoses (43 and 44) because are certified in food product dispensing systems, in which for connecting output pressure manometers (21, 23) the measure of the hoses is 3,75 mm. The other flexible couple of hoses measure 6,35 mm and are connected to the manometers (22, 24).

In addition, for both regulators (35, 36) there is an outlet valve (45, 46) to regulate the output, these are joined in a “T” connection and one comes out towards the electrovalve (37). Then, a flexible one appears with a cut in the line because it connects the anemometer (38) to visualize the passage of nitrous oxide and control it. Once the process has been realized, the flow continuous through the line (46) until proceeds to the nitrous oxide (11).

The cable used in this process is halogen-free and non combustible materials are used.

Finally, it is understood that the detailed description is given with illustrations and a well-educated person can make modifications and variations without differing or ignoring the invention.

1. A machine to charge whipping kitchen siphons especially for “whipped cream” through the automatic injection of nitrous oxide (N2O) which allows to optimize the charge time, availability of the nitrous oxide and security and operation control comprising
a first enclosure defining a first compartment with an open front part in which a base has a conjunction of nitrous oxide from a high pressure nitrous oxide cylinder with at least 500 g of work capacity, external to first compartment, the conjunction of nitrous oxide defines additional means of connection with a load python for the kitchen siphon;
a second enclosure defining a second compartment, with a door, having a high pressure nitrous oxide cylinder with the appropriate pneumatic and electronic connections, herein in front of the enclosure there is a control panel that allows operating the machine with at least one selector switch, lights, a start-up switch and a reset selector.

2. The machine to charge kitchen siphons according to claim 1 wherein the second compartment is below the first compartment.

3. The machine to charge kitchen siphons according to claim 1 wherein the second compartment is behind the first compartment.

4. The machine to charge kitchen siphons according to claim 1 wherein the second compartment is in lateral form to the first compartment.

5. The machine to charge kitchen siphons according to claim 1, wherein the first compartment where the base is located there is a conjunction of nitrous oxide which does not have two walls and a roof.

6. The machine to charge kitchen siphons according to claim 1, wherein the high pressure nitrous oxide cylinders are connected with manometers that work with two pressures, wherein a first pressure works with an output pressure and a second pressure measures a loading pressure.

7. The machine to charge kitchen siphons according to claim 6, wherein the high pressure nitrous oxide cylinders are connected to pressure regulators having an output valve to regularize output through an electrovalve and anemometer to visualize and control the passage of the nitrous oxide.

8. The machine to charge kitchen siphons according to claim 7, wherein the first compartment contains a control which works with signals and an infrared sensor to detect the kitchen siphon, a selector switch and a start-up selector that commands lights, a video display screen and an electro valve, and a variable of time in which the electro valve is activated keeping a counting system of charges of nitrous oxide.

9. The machine to charge kitchen siphons according to claim 1, further comprising a wheel system to make an easier transportation and without complications.

10. The machine to charge kitchen siphons according to claim 8, wherein the control has a remote connection to operate remotely.

11. A process for charging kitchen siphons for whipped cream through the automatic injection of nitrous oxide which allows optimizing the charge time, availability of the nitrous oxide and security and operation control according to claim 1, comprising:
inserting the kitchen siphon previously charged with cream and syrup into the nitrous oxide discharge set, then, from the machine rotate the siphon into the nitrous oxide discharge assembly, in clockwise direction;
operating the selector switch by turning to the “on” position;
checking that the machine has the pilot light on;
start loading transferring the nitrous oxide from the high pressure cylinders to the siphon through the pneumatic and electronic connections of the machine, activating the start-up selector once, then, the pilot light will come on indicating the start of the load or charge, thereafter wait 40 seconds until the pilot light goes off and the pilot light is on again, after this, the charge will be completed, wherein for more aeration, longer time and less cream is needed and for less aeration, less time and more cream is needed;
removing the siphon already charged and ready to make cream from the nitrous oxide discharge, wherein the machine is ready to start a new loading process for a new kitchen siphon, and if necessary a reset selector can be used;
checking the control panel for replacement of high pressure nitrous oxide cylinder.
